(19) United States
(12) Patent Application Publication
(10) Pub. No.: US 2018/0067768 A1
(43) Pub. Date: Mar. 8, 2018

(54) SYSTEM AND METHOD FOR DATA PATH AWARE THERMAL MANAGEMENT IN A PORTABLE COMPUTING DEVICE

(71) Applicant: QUALCOMM INCORPORATED, San Diego, CA (US)

(72) Inventors: VAIBHAV BHALLA, Hyderabad (IN); KRISHNA VSSSR VANKA, Hyderabad (IN); MURALI DHULIPALA, Rayakuduru (IN)

(21) Appl. No.: 15/257,691

(22) Filed: Sep. 6, 2016

(51) Int. Cl. G06F 9/48

(52) U.S. Cl. CPC G06F 9/4893

(57) ABSTRACT

Methods and systems for data path aware thermal management in a portable computing device (“PCD”) are disclosed. A trigger event may be received at a thermal module in the PCD. The thermal module also receives thermal information about a plurality of processing components of the PCD in response to the trigger event, the thermal information including a temperature at the locations of the plurality of processing components. The thermal module also receives thermal information about at least one subsystem in response to the trigger event, the thermal information including temperature modeling information about the at least one subsystem and a second temperature at the location of the at least one subsystem. A thermal impact from the plurality of processing components executing a task over a period of time is predicted and a determination is made which processing component has the smallest amount of thermal impact from executing the task.

### DESCRIPTION OF THE RELATED ART

Computing devices, including desktop computers, servers, and portable computing devices (“PCDs”) are ubiquitous. PCDs for example are becoming necessities for people on personal and professional levels. These devices may include cellular telephones (such as smartphones), portable digital assistants (“PDAs”), portable game consoles, palmtop computers, tablet computers, wearable and other portable electronic devices.

As computing devices become more powerful and are required to perform more tasks, thermal energy management within, and among the components of, computing devices is an increasing focus. Cooling devices, like fans, are often found in larger computing devices such as laptop and desktop computers. Additionally, passive cooling techniques or devices, such as the spatial arrangement of components within a computing device may be used to try and manage thermal energy of and among the electronic components of the computing device.

Such passive cooling techniques may be especially effective for PCDs to manage thermal energy, as well as to manage the temperature of the outer shell of the PCD felt by a user (“skin temperature”). There usually is not enough space within a PCD for precise thermal management using passive cooling components. Therefore, PCDs may rely on temperature sensors embedded on the PCD chip to monitor the thermal energy, and use the measurements to apply thermal management techniques that adjust workload allocations, processing speeds, etc., to reduce thermal energy.

However, such reactive thermal management is slow to reduce or mitigate thermal hotspots in the computing device. Such reactive thermal management can also result in inefficient processing of workloads, with tasks reassigned multiple times to different cores or processors as different hotspots arise within the device. Thus, such reactive thermal management may unnecessarily degrade the performance of a computing device and/or unnecessarily reduces the quality of service (“QoS”) provided to the user of the device. Therefore, there is a need for system and methods for active data path aware thermal management of computing devices, including PCDs, rather than purely reactive thermal management.

### SUMMARY OF THE DISCLOSURE

Various embodiments of methods and systems data path aware thermal management in a portable computing device (PCD) are disclosed. In an exemplary embodiment, a trigger event is received at a thermal module the PCD. The thermal module also receives thermal information about a plurality of processing components of the PCD in response to the trigger event, the thermal information including a temperature at the locations of the plurality of processing components. The thermal module also receives thermal information about at least one subsystem in response to the trigger event, the thermal information including temperature modeling information about the at least one subsystem and a second temperature at the location of the at least one subsystem. A thermal impact from the plurality of processing components executing a task over a period of time is predicted and a determination is made which processing component has the smallest amount of thermal impact from executing the task. The task is then assigned to the determined one of the plurality of processing components with the smallest amount of thermal impact.

Such methods and systems described above may be incorporated into PCDs which have no active cooling devices, like fans. That is, these methods and systems are designed to operate in PCDs that operate on battery power and which do not have active and power-consuming/hungry cooling devices, like fans.

In another embodiment, a computer system for data path aware thermal management in a PCD is disclosed. The exemplary system comprises a plurality of processing components of a system on a chip (“SoC”) of the PCD; a network on a chip (“NOC”) bus of the SoC, the NOC bus in communication with the plurality of processing components; a plurality of temperature sensors of the SoC in communication with the NOC bus, the plurality of temperature sensors configured to measure temperature at a plurality of junction points of the SoC; and a thermal module of the SoC.

The thermal module is configured to receive a trigger event and receive and/or compute thermal information about the plurality of processing components of the SoC in response to the trigger event. The thermal information includes the temperature at a first set of the plurality of junction points of the SoC at the location of the plurality of processing components. The thermal module is also configured to receive thermal information about at least one subsystem of the SoC in response to the trigger event. This thermal information includes temperature modeling information about the at least one subsystem and the temperature of the SoC at a second set of the plurality of junction points of the SoC at the location of the at least one subsystem. Finally, the thermal module is configured to compute or determine a one of the plurality of processing components with the smallest amount of thermal impact from executing a task over a period of time, the determination based in part on the temperature at the first and second set of the plurality of junction points.

Advantageously, by placing tasks among various cores or processors and/or subsystems based on predicted thermal considerations, the occurrence of hot spots in the PCD may be minimized or prevented, such that reactive thermal mitigation techniques are not required to mitigate the hot spots. Such predictive placement of tasks avoids unnecessary reductions in PCD performance and/or reductions in QoS for the PCD, without risking either thermal degradation of the PCD components or an unpleasant experience for the PCD user such as from an excessive skin or “touch” temperature of the external surfaces of the PCD.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an example embodiment of a portable computing device (PCD) in which systems and methods for data path aware thermal management can be implemented;

FIG. 2 is a block diagram showing an exemplary “floor plan” or spatial arrangement of components in a system on a chip (SoC) that may be implemented in a PCD;

FIG. 3 is a block diagram showing an exemplary embodiment of a system for data path aware thermal management;

FIG. 4A is the block diagram of FIG. 2, on which an example of the operation of the systems and methods for data path aware thermal management are illustrated;

FIG. 4B is the block diagram of FIG. 2, on which another example of the operation of the systems and methods for data path aware thermal management are illustrated;;

FIG. 5 is a logical flowchart illustrating an exemplary method for data path aware thermal management; and

FIG. 6 is a logical flowchart illustrating exemplary operation of portions of the exemplary method of FIG. 5.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system” and the like are intended to refer to a computer-related entity, either hardware, firmware, a combination of hardware and software, software, or software in execution and represent exemplary means for providing the functionality and performing the certain steps in the processes or process flows described in this specification. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).”

In this description, it will be understood that the terms “thermal” and “thermal energy” may be used in association with a device or component capable of generating or dissipating energy that can be measured in units of “temperature.” Consequently, it will further be understood that the term “temperature,” with reference to some standard value, envisions any measurement that may be indicative of the relative warmth, or absence of heat, of a “thermal energy” generating device or component. For example, the “temperature” of two components is the same when the two components are in “thermal” equilibrium.

In this description, the terms “skin temperature” and “outer shell temperature” and the like are used interchangeably to refer to a temperature associated with the outer shell or cover aspect of a PCD, such as a back cover, or a touchscreen or other display, of the PCD. As one of ordinary skill in the art would understand, the skin temperature of a PCD may be associated with a sensory experience of the user when the user is in physical contact with the PCD.

In this description, the terms “workload,” “process load” and “process workload” are used interchangeably and generally directed toward the processing burden, or percentage of processing burden, associated with a given processing component in a given embodiment, such as when that processing component is executing one or more task or instruction. Further, a “processing component” may be, but is not limited to, a system-on-a-chip (“SoC”), a central processing unit, a graphical processing unit, a core, a main core, a sub-core, a processing area, a hardware engine, a camera, a modem, etc. or any other component residing within, or external to, an integrated circuit within a portable computing device.

In this description, the terms “thermal mitigation technique(s),” “thermal policies,” “thermal management,” “thermal mitigation measure(s) and the like are used interchangeably. Notably, one of ordinary skill in the art will recognize that, depending on the particular context of use or “use case,” any of the terms listed in this paragraph may serve to describe hardware and/or software operable to increase performance at the expense of thermal energy generation, decrease or prevent thermal energy generation at the expense of performance, or alternate between such goals.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a tablet computer, a combination of the aforementioned devices, a laptop computer with a wireless connection, and/or wearable products, among others.

In PCDs, the tight spatial arrangement of thermally aggressive components, systems, and/or subsystems lends to excessive amounts of heat being produced, such as for example when those certain components are asked to process workloads at high performance levels and/or to perform ongoing tasks. In some cases, the temperature threshold of the components, or an area of the PCD where the components are located are the limiting factor in just how much thermal energy the components within the PCD are allowed to produce. In such cases, exceeding or approaching the temperature threshold of a component or a region of the PCD, a so-call “hotspot” may result in thermal mitigation algorithms reactively determining to address the hotspot, such as by reassigning tasks or workload from the component causing the hotspot and/or reducing the processing performance of the component.

Additionally, the temperature threshold may be set by an external touch or “skin” temperature experienced by a user. For example, the skin temperature threshold may be dictated by the maximum temperature to which a user may be exposed and not the maximum temperature to which the components within the PCD may be exposed. That is, the user experience as measured by the skin temperature of the PCD may be a factor from which a thermal mitigation algorithm may determine to reassign tasks or workload from the component causing the skin temperature issue and/or reducing the processing performance of the component.

However, it has been determined that such reactive thermal mitigation techniques may be slow to reduce the desired temperatures or hotspots in a PCD. Further such reactive thermal mitigation techniques may cause tasks or workloads to be reassigned multiple times from various cores or processors as new hotspots are created. Thus, it has been determined that reactive thermal mitigation techniques do not provide satisfactory thermal management.

It has been further determined that knowing the current operational state of a PCD, as well as the footprint or spatial arrangement of processing components and other components of a PCD, allow prediction of the thermal impact of executing a task or instruction at various components of the PCD. Knowing this thermal impact of executing a task or instruction, as well as the components and subsystems required to execute the task or instruction—i.e. the data path for the task or instruction—allows the task or instruction to be placed at the processing or other component least likely to create hotspots in the PCD.

Thus, the present systems and methods for data path aware thermal management provide a cost effective ability to adaptively and predictively apply thermal management to prevent hotspots from forming, and to therefore prevent the need for inefficient thermal mitigation strategies for such hotspots. The present systems and methods are particularly beneficial in a PCD environment since PCDs rely on throttling and power savings modes to control thermal conditions much more than do other computing environments, such as desktop computers, where other cooling mechanisms such as cooling fans are available.

The system and methods for data path aware thermal management described herein, or portions of the system and methods, may be implemented in hardware or software. If implemented in hardware, the systems, or portions of the systems can include any, or a combination of, the following technologies, which are all well known in the art: sensors, discrete electronic components, integrated circuits, application-specific integrated circuits having appropriately configured semiconductor devices and resistive elements, etc. Any of these hardware devices, whether acting or alone, with other devices, or other components such as a memory may also form or comprise components or means for performing various operations or steps of the disclosed methods.

When a system or method described herein is implemented, or partially implemented, in software, the software portion can be used to perform the methods described herein. The software and data used in representing various elements can be stored in a memory and executed by a suitable instruction execution system (e.g. a microprocessor). The software may comprise an ordered listing of executable instructions for implementing logical functions, and can be embodied in any “processor-readable medium” for use by or in connection with an instruction execution system, apparatus, or device, such as a single or multiple-core processor or processor-containing system. Such systems will generally access the instructions from the instruction execution system, apparatus, or device and execute the instructions

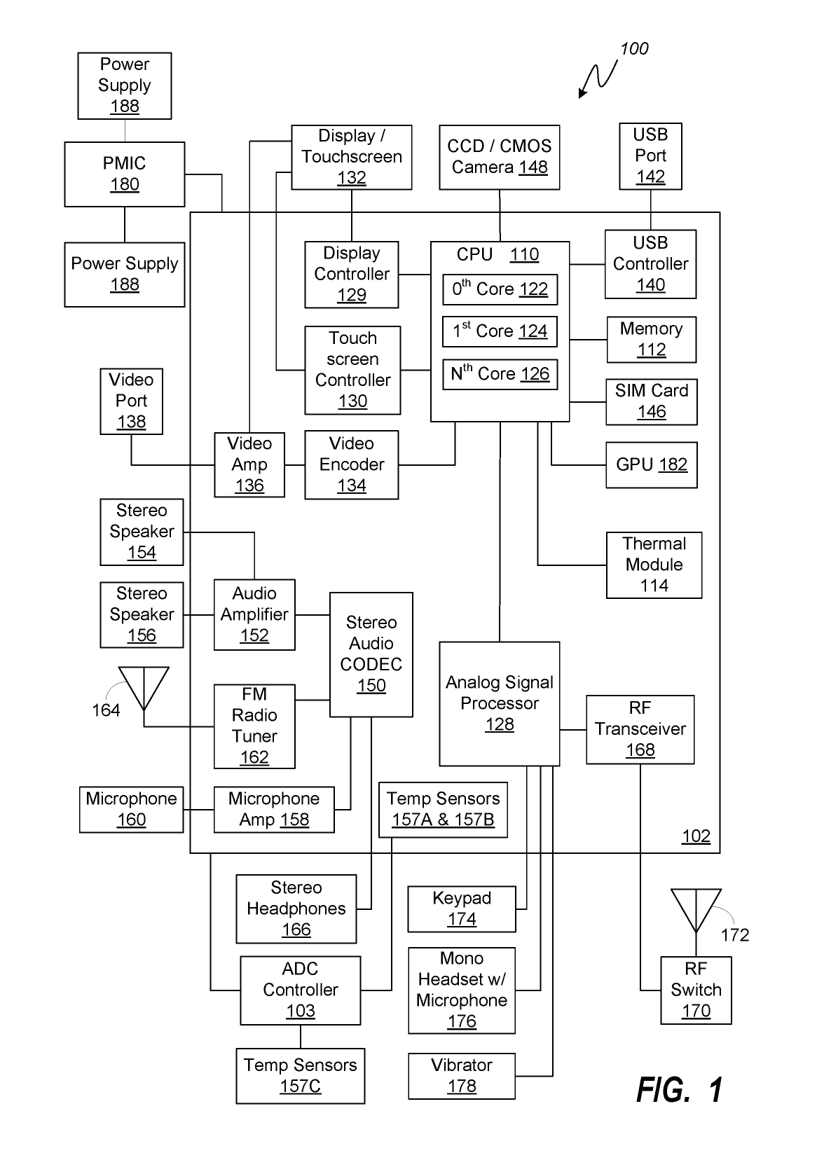

FIG. 1 is a functional block diagram illustrating an example embodiment of a portable computing device (PCD) in which systems and methods for data path aware thermal management can be implemented. As shown, the PCD 100 includes an on-chip system (“SoC”) 102 that includes a multi-core central processing unit (“CPU”) 110 and an analog signal processor 128 that are coupled together. The CPU 110 may comprise multiple cores including a zeroth core 122, a first core 124, up to and including, an Nth core 126. Further, instead of a CPU 110, a digital signal processor (“DSP”) may also be employed as understood by one of ordinary skill in the art. As will be understood, the cores 122, 122, 126 may be implemented to execute one or more instructions or tasks, such as instructions or tasks of an application being run by the PCD 100. As will also be understood, such instructions or tasks may instead, or may additionally, be executed by or on one or more additional processing components, such as GPU 182 illustrated in FIG. 1.

In an embodiment, a thermal prediction module (thermal module114) may be implemented to communicate with multiple operational sensors (e.g., thermal sensors 157A, 157B) distributed throughout the on-chip system 102, with the CPU 110 of the SoC 102, as well as components of the PCD 100 outside of the SoC 102. The thermal module 114 may also in some embodiments determine which among available processors (such as cores 122, 124, 126) or other subsystems to place one or more tasks or instructions based on thermal management considerations as described below. Although shown as a single component on the SoC 102 for convenience in FIG. 1, the thermal module 114 may in some embodiments comprise multiple components one, some, or all of which may not be located on the SoC 102. It is not necessary in the present disclosure for the thermal module 114 to be located on the SoC 102, and in some embodiments the thermal module 114 may be located outside the SoC 102.

As illustrated in FIG. 1, a display controller 129 and a touch screen controller 130 are coupled to the CPU 110. A touch screen display 132 external to the SoC 102 is coupled to the display controller 131 and the touch screen controller 130. Again, although shown in FIG. 1 as single components located on the SoC 102, both the display controller 131 or touch screen controller 130 may comprise multiple components, one or more of which may not be located on the SoC 102 in some embodiments.

PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the CPU 110. A video amplifier 136 is coupled to the video encoder 134 and the touch screen display 132. A video port 138 is coupled to the video amplifier 136. As depicted in FIG. 1, a universal serial bus (“USB”) controller 140 is coupled to the CPU 110. In addition, a USB port 142 is coupled to the USB controller 140. A memory 112 and a subscriber identity module (SIM) card 146 may also be coupled to the CPU 110. Further, as shown in FIG. 1, a digital camera 148 may be coupled to the CPU 110 of the SoC 102. In an exemplary aspect, the digital camera 148 is a charge-coupled device (“CCD”) camera or a complementary metal-oxide semiconductor (“CMOS”) camera.

As further illustrated in FIG. 1, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. In addition, an FM antenna 164 is coupled to the FM radio tuner 162. Further, stereo headphones 166 may be coupled to the stereo audio CODEC 150.

FIG. 1 further indicates that a radio frequency (“RF”) transceiver 168 may be coupled to the analog signal processor 128. An RF switch 170 may be coupled to the RF transceiver 168 and an RF antenna 172. As shown in FIG. 1, a keypad 174 may be coupled to the analog signal processor 128. In addition, a mono headset with a microphone 176 may be coupled to the analog signal processor 128. Further, a vibrator device 178 may be coupled to the analog signal processor 128. FIG. 1 also shows that a power supply 188, for example a battery, is coupled to the SoC 102 through PMIC 180. In a particular aspect, the power supply includes a rechargeable DC battery or a DC power supply that is derived from an alternating current (“AC”) to DC transformer that is connected to an AC power source.

The CPU 110 may also be coupled to one or more internal, on-chip thermal sensors 157A, 157B as well as one or more external, off-chip thermal sensors 157C.

The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157C may comprise one or more thermistors or other desired sensors. The thermal sensors 157C may produce a voltage drop that is converted to digital signals with an analog-to-digital converter (“ADC”) controller 103. However, other types of thermal sensors 157A, 157B, 157C may be employed without departing from the scope of the invention.

In the embodiment illustrated in FIG. 1, the touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157C are external to the SoC 102. However, it should be understood that the thermal module 114 may also receive one or more indications or signals from one or more of these external devices by way of the analog signal processor 128 and the CPU 110 to aid in the real time management of the resources operable on the PCD 100. Additionally, as discussed above, the thermal module 114 may itself comprise one or more component external to the SoC 102 in some embodiments.

In a particular aspect, one or more of the method steps described herein may be implemented by executable instructions and parameters stored in a memory 112 that may form the monitor module(s) 114, or other components discussed herein. The instructions that form the module(s) 114 may be executed by the CPU 110, the analog signal processor 128, or another processor, in addition to the ADC controller 103, to perform the methods described herein. Further, the CPU 110, analog signal processor 128, the memory 112, the instructions stored therein, or a combination thereof may serve as a means for performing one or more of the method steps described herein.

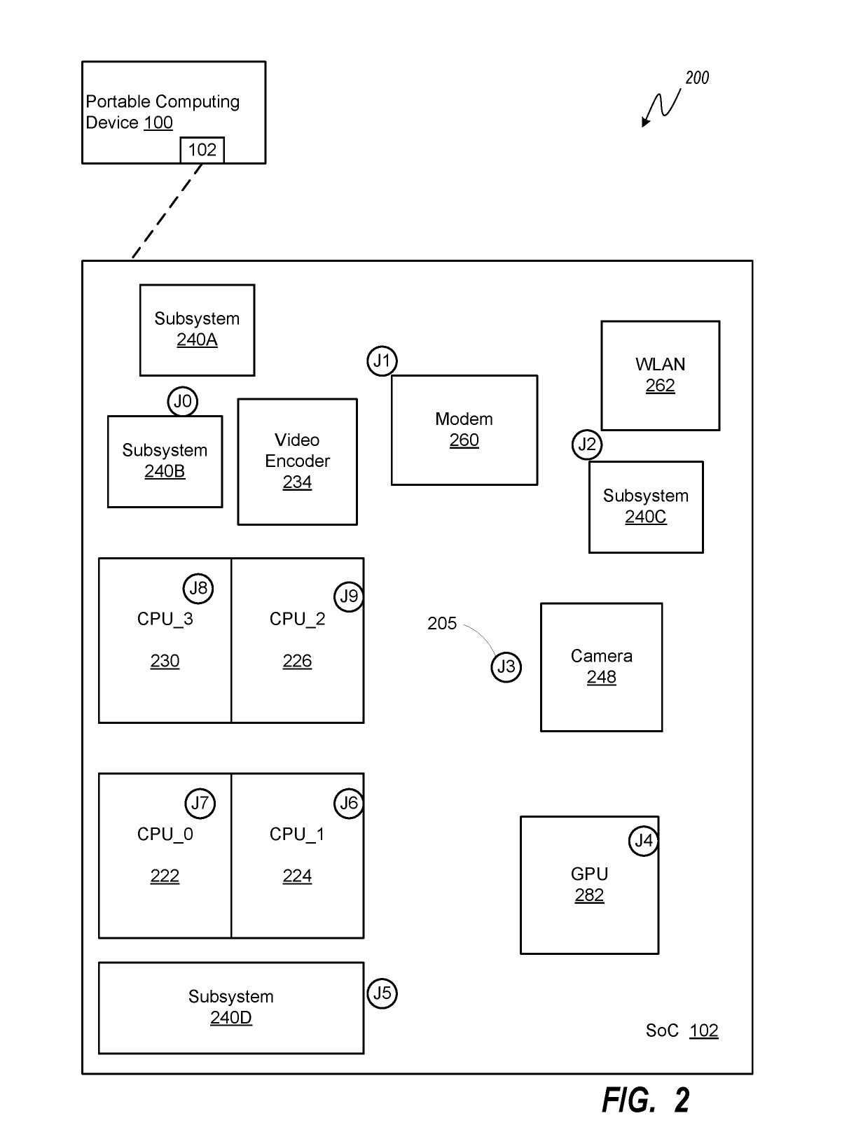

FIG. 2 is a block diagram showing an exemplary “floor plan” 200 or spatial arrangement of exemplary components of an SoC 102, such as the SoC 102 of PCD 100 illustrated in FIG. 1. The PCD 100 may in an embodiment be in the form of a wireless telephone in which systems and methods for data path aware thermal management can be implemented. FIG. 2 is for illustrative purposes, and shows an exemplary spatial arrangement of certain hardware components of the exemplary PCD 100, the hardware components depicted in block form.

As illustrated in FIG. 2, the SoC 102 may include multiple processors or cores, including CPU_0 222, CPU_1 224, CPU_2 226, and CPU_3 230 (collectively CPUs 222-230). Although four CPUs 222-230 are illustrated, in other embodiments the SoC 102 may have more or fewer CPUs 222-230 and/or the CPUs 222-230 may be arranged differently than illustrated in FIG. 2. Additionally, the SoC 102 may have a different architecture for the processing components than illustrated in FIG. 2, such as a “big-little” architecture with each of CPUs 222-230 comprising two separate processing components of different sizes. The present disclosure is equally applicable to all such architecture variations.

As also illustrated in FIG. 2, the SoC 102 may also comprise a separate GPU 282 for processing or executing graphics-related workloads, such as rendering graphical information to a user display (not illustrated in FIG. 2). Similarly, the SoC 102 may include a video encoder 234 for encoding or decoding video files. Although not illustrated, the SoC 102 may also include a separate audio encoder for encoding or decoding audio files and/or the audio portions of video files. SoC 102 may also include one or more cameras illustrated as camera 248 in FIG. 2. Similarly, SoC 102 may include one or more components to allow communications between the PCD 100 and other computer devices and systems. Such communication components may include modem 260 and/or wide area LAN (WLAN 262).

SoC 102 will also include one or more subsystems 240A-240D to support the components listed above and/or to perform other functionality for the SoC 102 or PCD 100. As will understood, these subsystems 240A-240D may include various components or logic configured to work in conjunction with or to work independently of the above-identified components of SoC 102. For example, in an embodiment subsystem 240D may comprise a low-power audio subsystem (LPASS) for handling audio data for the SoC 102. Similarly, in an embodiment subsystem 240B may include a video subsystem for handling video data for the SoC 102, such as video data to be encoded by video encoder 234 and/or video data to be rendered by GPU 282. SoC 102 may in various embodiments include more or fewer subsystems than subsystems 240A-240D.

Finally, in the embodiment illustrated in FIG. 2, the SoC 102 includes one or more temperature sensors 205 at various locations or junction points J0-J9 of the SoC 102. These sensors 205 allow present temperature information to be obtained at the identified junction points J0-J9. Based on the location of junction points J0-J9, these sensors 205 allow the present temperature of various processing components, such as CPUs 222-230, GPU 182, modem 260, etc., and/or the present temperature of various subsystems 240A-24D, to be obtained.

As will be understood, the SoC 102 may have more or fewer components and subsystems than those illustrated in FIG. 2 and/or the spatial arrangement of the components or subsystems arranged differently than the floorplan 200 illustrated in FIG. 2.

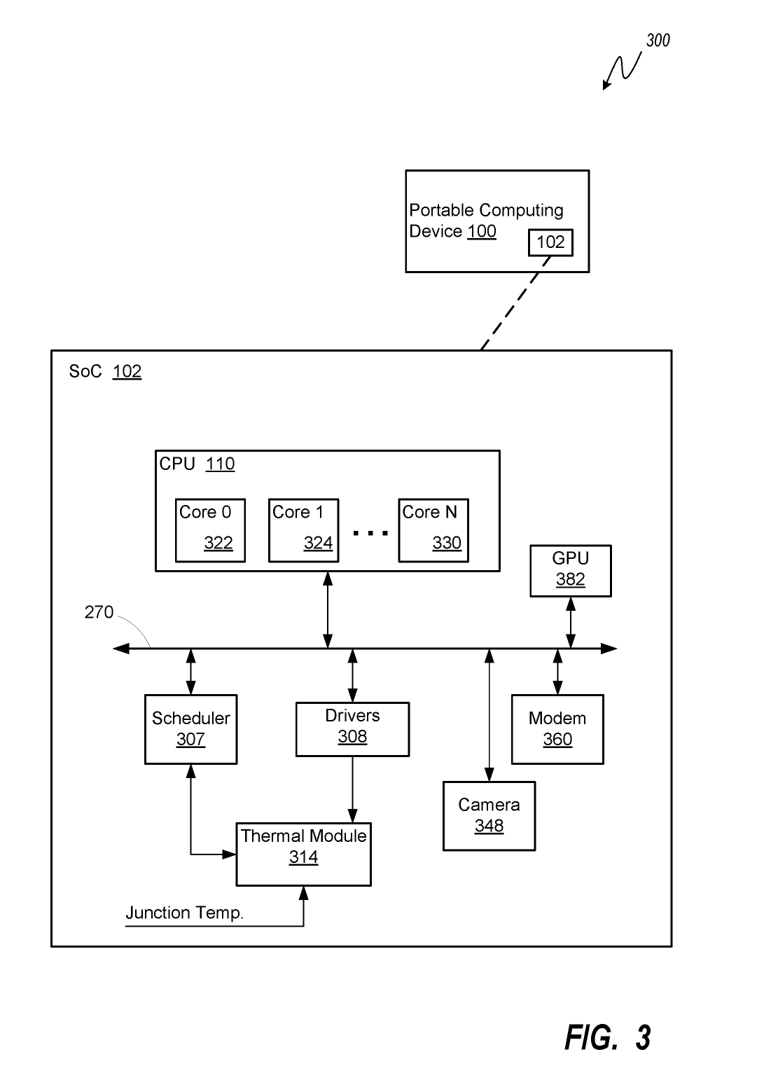

Turning to FIG. 3, a block diagram showing aspects of an exemplary embodiment of a system 300 for data path aware thermal management is illustrated. The system 300 may be implemented on an SoC 102 having the exemplary floor plan 200 of SoC 102 illustrated in FIG. 2. Additionally, the SoC 102 of system 300 may be the SoC 102 of PCD 100 illustrated in FIG. 1.

As illustrated in FIG. 3, the SoC 102 includes a CPU 110 with multiple processing components such as cores 322, 324, 330, which may correspond in an embodiment to CPUs 222-230 of FIG. 2. CPU 110 is electrically coupled to a communication path such an interconnect or bus 270. SoC 102 may also include GPU 382, modem 360, and camera 348 electrically coupled to the bus 270.

Bus 270 may include multiple communication paths via one or more wired or wireless connections, as is known in the art. Depending on the implementation, bus 270 may include additional elements, which are omitted for simplicity, such as controllers, buffers (caches), drivers, repeaters, and receivers, to enable communications. Further, bus 270 may include address, control, and/or data connections to enable appropriate communications among the various components illustrated in FIG. 3 and/or additional components of the SoC 102 and/or PCD 100 if desired. In an embodiment, bus 270 may comprise a network on chip (NOC) bus 270.

The system 300 includes a scheduler 307 in communication with bus 270, the scheduler 307 configured to cause tasks or instructions to be executed by the PCD 100 to be scheduled or assigned to one or more processing components, such as cores 322-330 of SoC 102. As will be understood, scheduler 307 may be a part or portion of an operating system for the PCD 100 executing on the SoC 102. The illustrated system 300 includes various drivers for the components of SoC 102 (illustrated as drivers 308) containing configuration and operation information about the components of SoC 102. Although illustrated in FIG. 3 as a single component, drivers 308 may be distributed among and/or co-located with the various components to which a particular driver applies.

System 300 also includes a thermal prediction module (thermal module 314) in communication with schedule 307 and drivers 308. In an embodiment the thermal module 314 may operate to predict the thermal impact of task(s) that the scheduler 307 is scheduling for execution. As discussed below, in order to make these determinations, thermal module 314 may receive or obtain information from the scheduler 307 such as the size and type of task, the cores or processors currently available to execute the task. Additionally, the thermal module 314 may receive or obtain additional information, either from scheduler 307 or elsewhere in the SoC 102 including information about the current load on each core, and/or the present leakage for each core which depends on the voltage at which a particular core is operating.

The thermal module 314 may also receive information from one or more drivers 308, such as drivers for various subsystems 240A-240B. Such information may include modeled information about the subsystem to allow understanding of the temperature and/or leakage of the subsystem under various loads. With this information, and with an understanding of which subsystems are currently active that may be determined or understood from information received from the scheduler 307 about which tasks are executing, the thermal module 314 can estimate or determine which subsystems are available to execute the task based, the current load on each subsystem, and/or the present leakage for each subsystem. The thermal module 314 will also receive temperature information about one or more junction points (such as junction points J0-J9 of FIG. 2) which indicates the current temperature at the locations of various subsystems and processing components that may be used or needed to execute the task.

Using this received or obtained information about the processing components and subsystems, and knowing the nature and size of the task as well as the floor plan of the processing components and subsystem, thermal module 314 may determine or estimate the thermal impact over time of executing the task on various processing components (such as CPUs 222-230 and/or GPU 282 of FIG. 2) and/or using one or more subsystems (such as subsystems 240A-240D of FIG. 2). Based on these determined or estimated thermal impacts, the thermal module 314 may cause the scheduler 307 to schedule the task for execution at a particular one of the available processing components. The thermal module 314 may alternatively, or additionally, cause the task to be executed using a particular one of the available subsystems, such as by causing one of the drivers 308 to select or execute the task with the desired subsystem. In this manner, thermal module 314 allows spatial location or data path aware scheduling of tasks by the scheduler 307, providing predictive thermal management to prevent hotspots and/or manage the thermal impact to the SoC 102 from the additional workload of the task.

Although shown as a separate, remote component in communication with the scheduler 307, the thermal module 314 may in some embodiments be co-located with the scheduler 307. In other embodiments, the thermal module 314 may be a portion of or logic contained in the scheduler 307. In yet other embodiments, the scheduler 307 and thermal module 314 may both be sub-components of a single larger component.

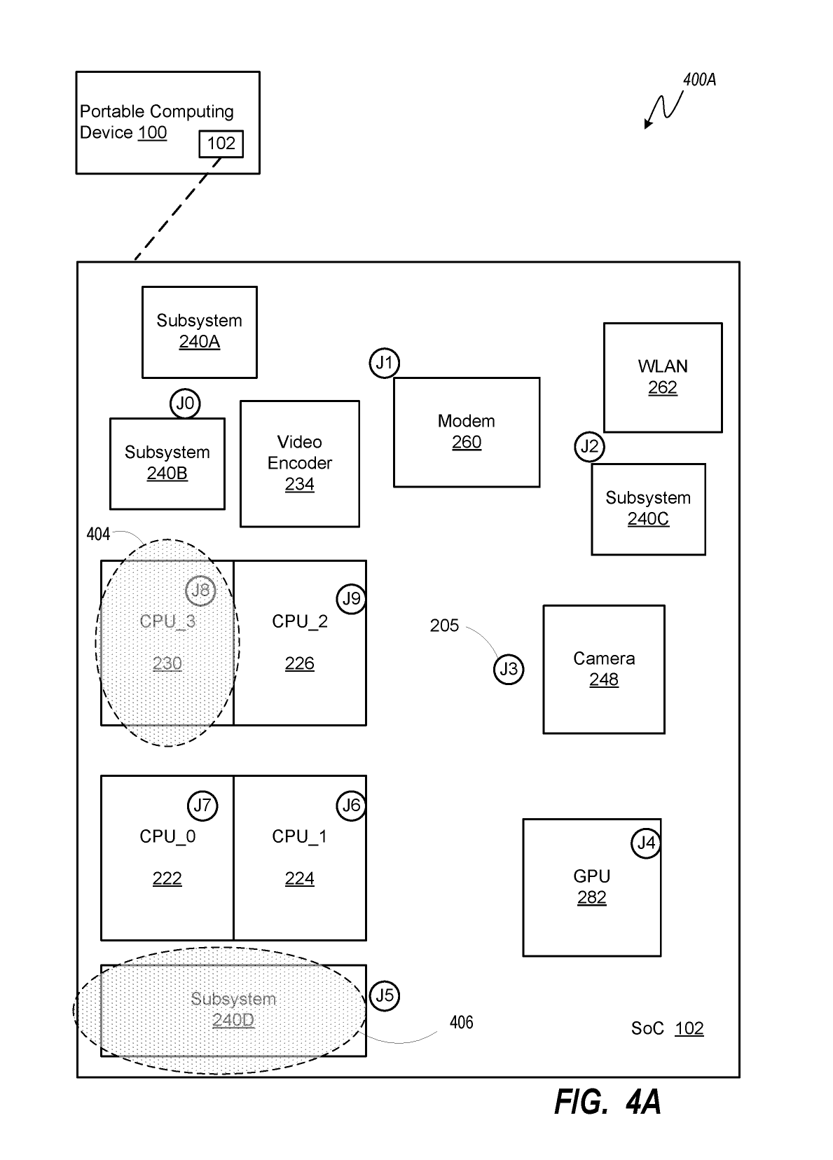

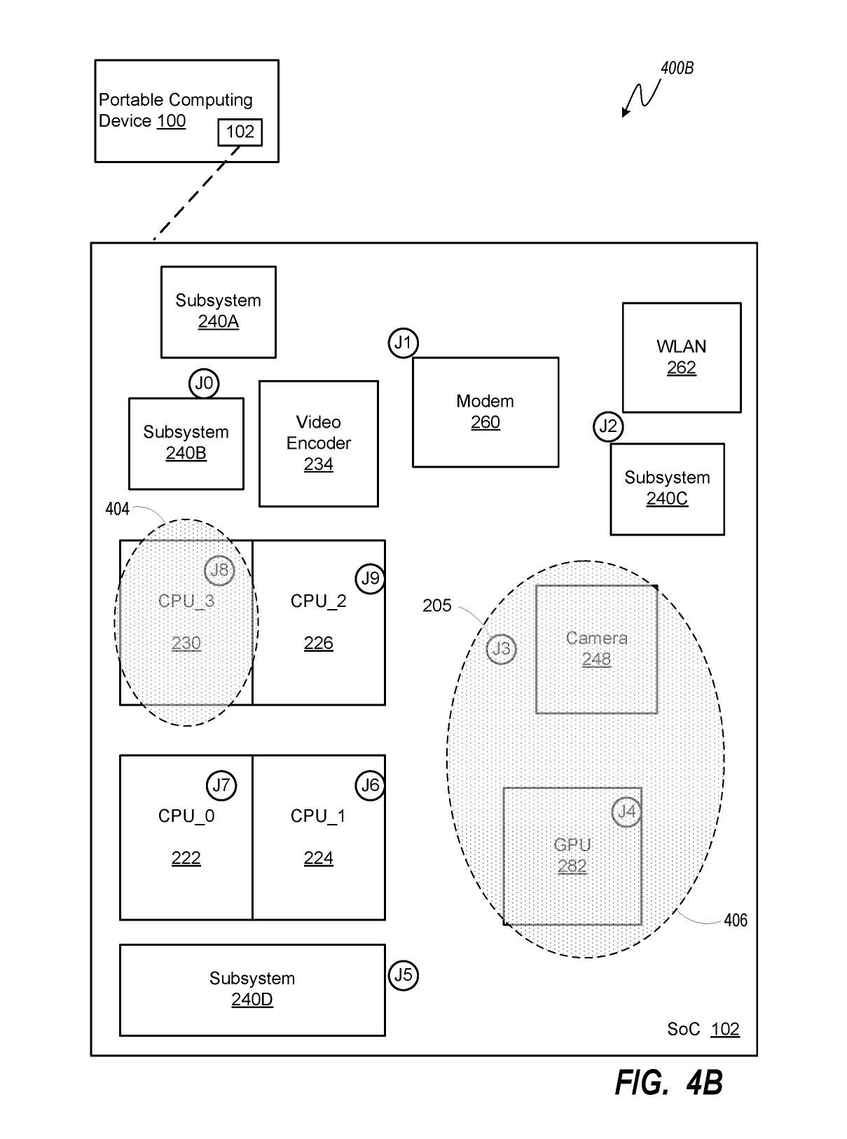

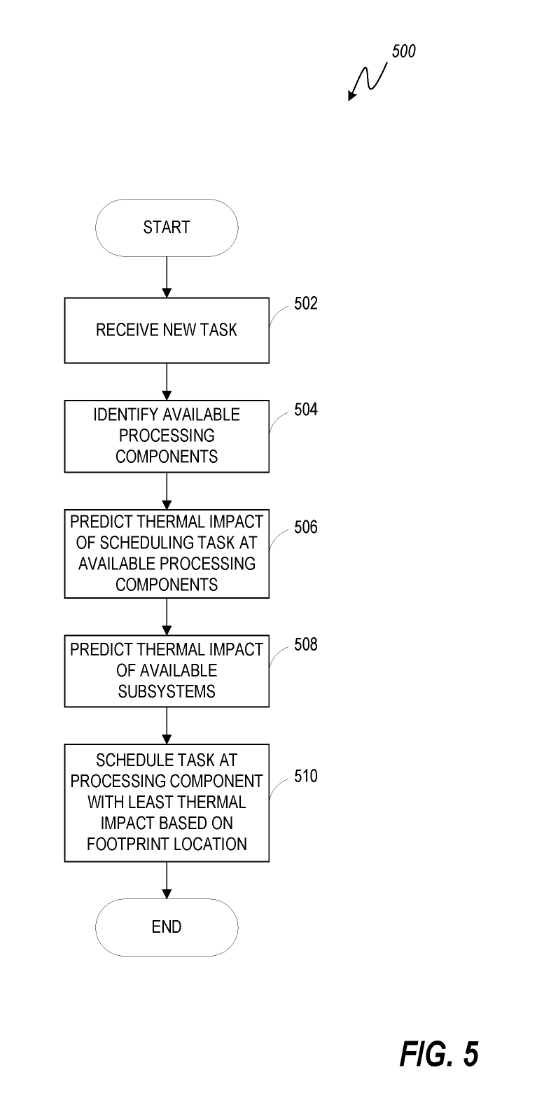

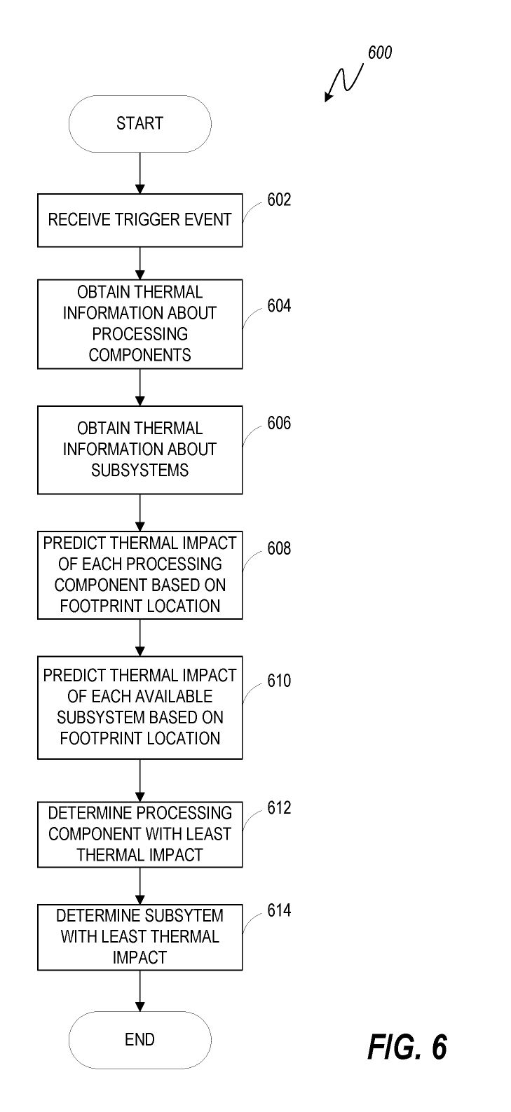

FIGS. 4A-4B illustrate examples of the operation of system 300 illustrated in FIG. 3(and methods 500 and 600 of FIGS. 5 and 6). FIGS. 4A-4B show the operation on an SoC 102 having the footprint 200 illustrated in FIG. 2. In the example of FIG. 4A, one of the CPUs, CPU_3 230 in this example, is executing one or more tasks creating heat indicated by shaded area 404. If a second task (new_task) comes in to the scheduler 307 (see FIG. 3), the scheduler 307 may alert or wake up the thermal module 314 in an embodiment and provide information about the loads on various processing components, such as CPUs 222-230 and GPU 282. Scheduler 307 may also provide the present voltage at which each processing component is operating, or thermal module 314 may obtain this voltage information from somewhere other than the scheduler 307. Based on the voltage information, the thermal module 314 can understand the present leakage for each processing component.

Continuing with the example of FIG. 4A, from the information obtained from the scheduler 307 about the tasks already operating on the SoC 102 and model information from one or more drivers 308, the thermal module 314 can understand or determine the present workloads and leakage of the various subsystems 240A-240D of SoC 102. In the example of FIG. 4A, one of the ssubsystems240D is being used to execute one or more already existing tasks creating heat indicated by shaded area 406.

Thermal module 314 also receives present temperature information about junction points J0-J9, such as from temperature sensors 205 located at or near these junction points. From this present temperature information, thermal module 314 is aware of the present temperature increase 404 at CPU_3 230 (from junction point J8) and the temperature increase 406 at subsystem 240D (from junction point J5).

In prior art systems, new_task would be scheduled for execution at any of CPU_0 222, CPU_1 224, CPU_2 226 and/or GPU 282 (depending on the type of task) based on the current conditions at those components, and without regard for the thermal impact scheduling new_task may have on the increased temperature areas 404 and 406 illustrated in FIG. 4A. In the present system 300 and methods 500/600, new_task would not be scheduled for execution at either CPU_0 222 or CPU_1 224 based on the currently raised temperature areas 404 and 406 that are caused by the already existing workloads on CPU_3 230 and subsystem 240D.

Instead, thermal module 314 would cause new_task to be scheduled for execution at CPU_2 226 (or GPU 282 depending on the type of task) in order to prevent further temperature increase at the spatial location near subsystem 240D—i.e. to prevent a future hotspot as new_task is executed over time. Additionally, thermal module 314 would determine if an alternate to subsystem 240D, such as subsystem 240A, could assist in the execution of new_task (which depends on the type of task) and would cause such different subsystem 240A to assist in the execution of new_task if possible.

In this manner, thermal module 314 seeks to minimize future thermal impact from executing new_task based on the workload and current temperature of processing components, and also based on the data path such as the subsystems required for execution of new_task. Knowing the workload needed to execute the new task and any current “hot spots” 404 and 406 on the SoC 102, thermal module 314 predicts or estimates the thermal impact of executing new_task on the various available processing components and subsystems. Thermal module 314 then causes new_task to be scheduled for execution by the data path—i.e. processing component and subsystem—with the least future estimated thermal impact to SoC 102. In the example of FIG. 4A, thermal module 314 selects a data path for new_task to avoid further increasing current hot spots 404 and 406, such as a data path comprising CPU_2 226 and subsystem 240A.

Turning to FIG. 4B, a second example of the operation of system 300 illustrated in FIG. 3 (and methods 500 and 600 of FIGS. 5 and 6). FIG. 4B also shows the operation on an SoC 102 having the footprint 200 illustrated in FIG. 2. In the example of FIG. 4B, CPU_3 230 is again executing one or more tasks creating heat indicated by shaded area 404. Additionally, camera 248 and GPU 282 are also operating and/or executing one or more tasks creating heat indicated by shaded area 406. If a second task (new_task) comes in to the scheduler 307 (see FIG. 3), the scheduler 307 may alert or wake up the thermal module 314 in an embodiment and provide information about the loads on various processing components, such as CPUs 222-230 and GPU 282.

Scheduler 307 may also provide the present voltage at which each processing component is operating, or thermal module 314 may obtain this voltage information from somewhere other than the scheduler 307. Based on the voltage information, the thermal module 314 can understand the present leakage for each processing component. From the information obtained from the scheduler 307 about the tasks already operating on the SoC 102 and model information from one or more drivers 308, the thermal module 314 can understand or determine the present workloads and leakage of the various subsystems 240A-240D of SoC 102. In the example of FIG. 4B, the camera 248 and associated subsystem to support camera 248 are being used to execute one or more already existing tasks, creating part of the heat indicated by shaded area 406.

Thermal module 314 also receives present temperature information about junction points J0-J9, such as from temperature sensors 205 located at or near these junction points. From this present temperature information, thermal module 314 is aware of the present temperature increase 404 at CPU_3 230 (from junction point J8) and the temperature increase 406 caused by GPU 282 (from junction point J4) and camera 248 (from junction point J3).

Again, in prior art systems, new_task would be scheduled for execution at any of CPU_0 222, CPU_1 224, CPU_2 226 and/or GPU 282 (depending on the type of task) based on the current conditions at those components, and without regard for the thermal impact scheduling new_task may have on the increased temperature areas 404 and 406 illustrated in FIG. 4A. In the present system 300 and methods 500/600, new_task would not be scheduled for execution at either CPU_1 224 or CPU_2 226 based on the currently raised temperature areas 404 and 406 that are caused by the already existing workloads on CPU_3 230 and camera 248/GPU 282.

Instead, thermal module 314 would cause new_task to be scheduled for execution at CPU_0 222 and/or another subsystem or processing component in order to prevent further temperature increase at areas 404 and 406—i.e. to prevent a future hotspot as new_task is executed over time. Additionally, even if new_task is a graphics related task that would normally be scheduled at GPU 282, the thermal module 314 will try and cause such graphics related task to instead be scheduled at an alternate processing component or subsystem, such as for example at an alternate processor (such as CPU_0 222) or an alternate component/subsystem such as a mobile display processor that may perform graphics related tasks normally sent to GPU 282.

In this manner, thermal module 314 again seeks to minimize future thermal impact from executing new_task in the example of FIG. 4B based on the workload and current temperature of processing components, and also based on the data path such as the subsystems required for execution of new_task. Knowing the workload needed to execute the new task and any current “hot spots” 404 and 406 on the SoC 102, thermal module 314 predicts or estimates the thermal impact of executing new_task on the various available processing components and subsystems.

Thermal module 314 then causes new_task to be scheduled for execution by the data path—i.e. processing component and subsystem—with the least future estimated thermal impact to SoC 102. In the example of FIG. 4B, thermal module 314 selects a data path for new_task to avoid further increasing current hot spots 404 and 406, such as a data path comprising CPU_0 222 and subsystem 240A and/or alternate component such as mobile display processor (not illustrated) that may perform graphics tasks instead of GPU 282.

FIG. 5 is a logical flowchart illustrating an exemplary method 500 for data path aware thermal management, such as in PCD 100 of FIG. 1-3 or 4A-4B. Method 500 may be performed by a system such as system 300 illustrated in FIG. 3. The illustrated method 500 begins in block 502 with the receipt of a new task (new_task_) for execution by the PCD 100 being received. In an embodiment, the new_task received in block 502 may be received by scheduler 307 of SoC 102 illustrated in FIG. 3.

In block 504, CPU cores or processing components available to execute new_task are identified. The identification of available processors or cores in block 504 may be performed by scheduler 307 in some embodiments. In other embodiments, the identification in block 504 may be made by a different component, such as thermal module 314 (see FIG. 3). The identification in block 504 may be based in part on the type of task (e.g. whether the SoC 102 has processing components dedicated or configured to execute the particular type of task) or the present workload of the processing components (e.g., whether one or more processing component is already operating at full capacity such that it may not take on additional tasks).

Method 500 continues to block 506 where the thermal impact of scheduling the new task (new_task) at the available cores is predicted or estimated. In an embodiment, the prediction in block 506 is performed by thermal module 314 (see FIG. 3) and is performed for each of the available cores identified in block 504. The predictions or estimations in block 506 for each available core may be based in part on one or more of the present load of each of the available cores, the present leakage of each of the available cores (which may be calculated in an embodiment based on the present voltage level of the core), the expected workload to execute new_task, and the present temperature at the spatial location of each of the available cores (which may be measured at the applicable junction point J0-J9 illustrated in FIG. 2). In an embodiment, the prediction or estimation of the thermal impact at block 506 includes an estimation of the increase in temperature at the spatial location of each available core over the time period expected for the execution of new_task.

In block 508 the thermal impact of scheduling the new task (new_task) at the available subsystems is predicted or estimated. In an embodiment, the prediction in block 508 is also performed by thermal module 314 (see FIG. 3) and is performed for each of the subsystems available, or able, to assist in (or to perform) the execution of new_task. Note that, depending on the type of task, only one or only a small number of subsystems may be available to assist in or to perform the execution of new_task. For example, if new_task comprises audio data, such new_task may necessarily require use of a low power audio subsystem (LPASS). In such embodiments, the prediction or estimation in block 508 may still be performed to understand the expected or predicted temperature increase caused by the execution of the task by the required subsystem.

The determination or estimation in block 508 may be based in part on the type of task (e.g. whether the SoC 102 has subsystems dedicated or configured to execute the particular type of task) or the present workload of the subsystems (e.g., whether one or more subsystem is already operating at full capacity such that it may not take on additional tasks). The predictions or estimations in block 508 for each available subsystem may be based in part on modeled information obtained from one or more drivers for each subsystem (such as drivers 308 in FIG. 3). Such modeled information may contain information to allow thermal module 314 to understand or determine the present load of each subsystem, the present leakage of each subsystem, the expected workload to execute new_task with the subsystem.

Additionally, the predictions or estimations of block 508 may also be made in part based on the present temperature at the spatial location of each of the available subsystems (which may be measured at the applicable junction point J0-J9 illustrated in FIG. 2). In an embodiment, the prediction or estimation of the thermal impact at block 508 includes an estimation of the increase in temperature at the spatial location of each available subsystem over the time period expected for the execution of new_task.

Based on the predictions in blocks 506 and 508 the new_task is scheduled in block 510 at the core (and potentially for the subsystem) with the least thermal impact, based in part on the footprint location of the core and/or subsystem. In an embodiment, the thermal module 314 determines or selects the core and/or subsystem at which to schedule the new_task, and causes scheduler 307 to schedule the task in block 510.

This selection by the thermal module 314 may be based on the predicted or estimated increase in temperature at the spatial location of the available cores/subsystems over the time period expected for the execution of new_task. This selection also takes into account the current temperature of various regions on the SoC 102, including increased temperature regions such as 404 and 406 in FIGS. 4A-4B. The determination of the core/subsystem with the least thermal impact may in an embodiment comprise the core and/or subsystem that will not increase the temperature of current “hot spots” (such as 404 and 406) or that will prevent the occurrence of hot spots on the SoC 102 during the execution of new_task. Method 500 then ends.

FIG. 6 is a logical flowchart illustrating an exemplary method 600 of operation of portions of the exemplary system 300 of FIG. 3 and/or portions of the exemplary method 500 of FIG. 5. In an embodiment, method 600 may be implemented by thermal module 314 of system 300 or may be implemented to perform one or more of blocks 506 and 508 of method 500.

Exemplary method 600 begins in block 602 with the receipt of a trigger event. In an embodiment, the trigger event of block 602 may comprise a notification from scheduler 307 that a new_task needs to be scheduled at a processing component of SoC 102. In other embodiments, the trigger may be a notification of some other event, such as a notification that a task (or tasks) has been completed. In yet other embodiments, the trigger event of block 602 may comprise a timer or other notification for the thermal module 314 to execute. In such embodiments the trigger event in block 602 may be generated internally by the thermal module 314 (such as by a timer of the thermal module 314) or may be received by the thermal module 314 from an external source (such as scheduler 307 or a separate external timer).

Thus, in addition to determining the appropriate processing component and/or subsystem when a new_task needs to be scheduled, thermal module 314 may periodically re-determine the appropriate processing component and/or subsystem for one or more on-going tasks executing on processing components of the SoC 102. Such re-determinations may be event based (such as the completion of one or more currently executing tasks), time based, or a combination of both in various embodiments.

In block 604 thermal information about processing components, such as CPU cores 322-330 (see FIG. 3) is obtained by the thermal module 314. In an embodiment, some of this thermal information may be provided by scheduler 307, such as in a message from the scheduler 307 that a new_task needs to be scheduled where such message includes information identifying available cores and/or a present workload of all of the cores on the SoC 102. In other embodiments, the thermal information may be obtained by thermal module 314 by polling or sending requests to various components such as scheduler 307, temperature sensors 205 (see FIG. 2), or other components of the SoC 102 in order to obtain the desired thermal information for all of the processing components of the SoC 102.

The thermal information obtained by the thermal module in block 604 may comprise the present load of the SoC's processing components, the present leakage of each of the processing components (which may be calculated in an embodiment based on the present voltage level of the processing component), the expected workload to execute any additional or new tasks to be scheduled on the processing component, and the present temperature at the spatial location of each of the processing components (which may be measured at the applicable junction point J0-J9 illustrated in FIG. 2). Thus, in block 604, the thermal module 314 obtains thermal information about all of the processing components of the SoC 102, not just the available cores or processing components at which a new or additional task may be scheduled.

Method 600 continues to block 606 where thermal information about the subsystems of the SoC 102 is obtained. As discussed, depending on the type of task, only one or only a small number of subsystems may be available to assist in or to perform the execution of a particular task. However, in block 606, thermal module 314 obtains thermal information about all of the subsystems in order to understand and take into account the thermal impact to such subsystems already operating on the SoC 102.

The thermal information in block 606 may be received periodically by the thermal module 314, or may be received in response to a request by the thermal module 314. In an embodiment, the thermal information may include pre-determined information about the subsystem operation, such as modeled information about the temperature, leakage, load, etc. of various subsystems when executing different types of tasks or when operating at various load levels. Such modeled information may be contained in, and obtained from, drivers for the subsystems, such as drivers 308 illustrated in FIG. 3. Additionally, the thermal information obtained in block 606 may also include present temperature at the spatial location of each subsystem, which may be measured at the applicable junction point J0-J9 illustrated in FIG. 2.

In block 608, the thermal impact of each processing component, such as CPU cores 322-330 (see FIG. 3) is estimated by the thermal module 314 based on the footprint location of the processing component. The prediction or estimation of the thermal impact at block 608 is based on thermal information obtained by thermal module 314 in block 604. In an embodiment, the prediction at block 608 is similar to the prediction discussed above for block 506 of FIG. 5, and may be based in part on one or more of the present load of each of the processing components, the present leakage of each of the processing components (which may be calculated in an embodiment based on the present voltage level of the processing component), the expected workload to execute one or more tasks, and the present temperature at the spatial location of each of the processing components (which may be measured at the applicable junction point J0-J9 illustrated in FIG. 2).

The prediction in block 608 is performed for each processing component, and may include an estimation of the increase in temperature at the spatial location of each processing component over the time period expected for the execution of a particular task, such as a new_task to be scheduled. In other embodiments, the prediction in block 608 may also include an estimation of the increase or decrease in temperature at the spatial location of each processing component over a time period that may be caused by a completion of a task, a re-allocation of a task from one processing component to another, etc.

In block 610, the thermal impact of each subsystem, such as subsystems 240A-240D (see FIG. 2) is estimated by the thermal module 314 based on the footprint location of the subsystem(s). The prediction or estimation in block 610 is made using the thermal information obtained by the thermal module 314 in block 606. In an embodiment, the prediction or estimation of the thermal impact at block 610 is similar to the prediction discussed above for block 508 of FIG. 5, and may be based in part on the modeled information obtained from one or more drivers for each subsystem (such as drivers 308 in FIG. 3).

Such modeled information may contain information to allow thermal module 314 to understand or determine the present load of each subsystem, the present leakage of each subsystem, the expected workload to execute tasks with the subsystem. Additionally, the predictions or estimations of block 508 may also be made in part based on the present temperature at the spatial location of each of the available subsystems (which may be measured at the applicable junction point J0-J9 illustrated in FIG. 2) that is also obtained in block 606.

The prediction in block 610 is performed for each subsystem, and may include an estimation of the increase in temperature at the spatial location of each subsystem over the time period expected for the execution of a particular task, such as a new_task to be scheduled. In other embodiments, the prediction in block 610 may also include an estimation of the increase or decrease in temperature at the spatial location of each subsystem over a time period that may be caused by a completion of a task, a re-allocation of a task from one subsystem to another, etc.

In blocks 612 and 614 the processing component or CPU core (block 612) and subsystem (block 614) are then determined. The determinations in blocks 612 and/or 614 may be similar to that discussed above for block 510 of method 500. Based on the predictions in blocks 608 (for processing components) and 610 (for subsystems) the thermal module 314 determines which processing component/CPU core (block 612) and which subsystem (614) creates the least thermal impact when executing a particular task, based in part on the footprint location of the core and/or subsystem.

These determinations by the thermal module 314 may be based on the predicted or estimated increase in temperature at the spatial location of each core/subsystem over the time period expected for the execution of an additional or new_task. In other embodiments, these determinations by the thermal module 314 may also be based on the predicted or estimated increase or decrease in temperature at the spatial location of each core/subsystem over a time period that may be caused by a completion of a task, a re-allocation of a task from one subsystem to another, etc.

These determinations in blocks 612 and 614 also take into account the current temperature of various regions on the SoC 102, including increased temperature regions such as 404 and 406 in FIGS. 4A-4B. The determinations of the core/subsystem with the least thermal impact may in an embodiment comprise the core and/or subsystem that will not increase the temperature of current “hot spots” (such as 404 and 406) over a particular time period or that will prevent the occurrence of hot spots on the SoC 102 during the time period. The thermal module 314 may communicate the determined processing components/CPU cores and subsystem to another component for action in some embodiments (not illustrated in FIG. 6), such as to scheduler 307. Method 600 then ends.

FIG. 5 describes only one exemplary embodiment of a method for data path aware thermal management in a PCD. Similarly, FIG. 6 describes one exemplary embodiment of a method of operation of thermal module 314 to provide predictive thermal management of the workloads on a PCD. In other embodiments, additional blocks or steps may be added to either method 500 or method 600. Similarly, in some embodiments various blocks or steps shown in FIG. 5 or FIG. 6 may be combined or omitted, such as for example combining blocks 506 and 508 of FIG. 5 into one predicting block/step rather than the two separate blocks/steps illustrated in FIG. 5. Similarly, in some embodiments, blocks 608 and 612 may be combined into one predicting/determining block or step for the processing components, while blocks 610 and 614 may be combined into one predicting/determining block or step for subsystems. Such variations of the methods 500 (FIGS. 5) and 600 (FIG. 6) are within the scope of this disclosure.

Additionally, certain steps in the processes or process flows described in this specification naturally precede others for the invention to function as described. However, the disclosure is not limited to the order of the steps described if such order or sequence does not alter the functionality. Moreover, it is recognized that some steps may performed before, after, or in parallel (substantially simultaneously) with other steps without departing from the scope of this disclosure. In some instances, certain steps may be omitted or not performed without departing from the scope of the disclosure. Further, words such as “thereafter”, “then”, “next”, “subsequently”, etc. are not intended to limit the order of the steps. These words are simply used to guide the reader through the description of the exemplary methods 500 and 600.

The various operations and/or methods described above may be performed by various hardware and/or software component(s) and/or module(s), and such component(s) and/or module(s) may provide the means to perform such operations and/or methods. Additionally, one of ordinary skill in programming is able to write computer code or identify appropriate hardware and/or circuits to implement the disclosed method or system without difficulty based on the flow charts and associated description in this specification, for example.

Therefore, disclosure of a particular set of program code instructions or detailed hardware devices is not considered necessary for an adequate understanding of how to make and use the disclosed system or method. The inventive functionality of the claimed processor-enabled processes is explained in more detail in the above description and in conjunction with the drawings, which may illustrate various process flows.

In one or more exemplary aspects as indicated above, the functions described may be implemented in hardware, software, firmware, or any combination thereof If implemented in software, the functions may be stored on or transmitted as one or more instructions or code on a computer-readable medium, such as a non-transitory processor-readable medium. Computer-readable media include both data storage media and communication media including any medium that facilitates transfer of a program from one location to another.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and Blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the scope of the present disclosure, as defined by the following claims.

What is claimed is:

1. A method for data path aware thermal management in a portable computing device (“PCD”), the method comprising:
receiving a trigger event at a thermal module of a system on a chip (“SoC”);
receiving at the thermal module thermal information about a plurality of processing components of the SoC in response to the trigger event, the thermal information including a temperature of the SoC at the locations of the plurality of processing components;
predicting a thermal impact from the plurality of processing components executing a task over a period of time;
determining with the thermal module a one of the plurality of processing components with the smallest amount of thermal impact from executing the task over the period of time, the determination based in part on the temperature of the SoC at the locations of the plurality of processing components and the second temperature of the SoC at the location of the at least one subsystem; and
assigning the task to the determined one of the plurality of processing components with the smallest amount of thermal impact.

2. The method of claim 1, wherein the task is a new task to be assigned to one of the processing components of the SoC.

3. The method of claim 2, wherein receiving a trigger event comprises receiving a signal from a scheduler of the SoC about the new task to be assigned, and wherein assigning the task to the determined one of the plurality of processing components comprises the scheduler assigning the new task to the determined one of the plurality of processing components.

4. The method of claim 1, wherein:
the SoC further comprises a network on chip (“NOC”) bus,
the plurality of processing components comprises a central processing unit with at least two cores, and a graphical processing unit (“GPU”), all coupled to the NOC bus, and
the SoC further comprises a camera and a modem coupled to the NOC bus.

5. The method of claim 4, wherein the thermal information about the plurality of processing components comprises:
a present load on the plurality of processing components and a present leakage of the plurality of processing components.

6. The method of claim 4, further comprising:
receiving at the thermal module thermal information about at least one subsystem of the SoC in response to the trigger event, the thermal information including temperature modeling information about the at least one subsystem and a second temperature of the SoC at the location of the at least one subsystem, and
wherein the determination with the thermal module of the one of the plurality of processing components with the smallest amount of thermal impact from executing the task over the period of time is further based in part on the second temperature of the SoC at the location of the at least one subsystem.

7. The method of claim 6, wherein the temperature modeling information about the at least one subsystem is provided to the thermal module by a driver of the SoC associated with the at least one subsystem, the temperature modeling information indicating a present load on the at least one subsystem and a present leakage of the at least one subsystem.

8. The method of claim 6, further comprising:
determining with the thermal module a subsystem with the smallest amount of thermal impact from executing the task over the period of time, the determination based in part on the temperature of the SoC at the locations of the plurality of processing components and the second temperature of the SoC at the location of the at least one subsystem; and
assigning the task to the determined subsystem with the smallest amount of thermal impact.

9. A computer system for data path aware thermal management in a portable computing device (“PCD”), the system comprising:
a plurality of processing components of a system on a chip (“SoC”) of the PCD;
a network on a chip (“NOC”) bus of the SoC, the NOC bus in communication with the plurality of processing components;
a plurality of temperature sensors of the SoC in communication with the NOC bus, the plurality of temperature sensors configured to measure temperature at a plurality of junction points of the SoC; and
a thermal module of the SoC, the thermal module configured to:
receive a trigger event,
receive thermal information about the plurality of processing components of the SoC in response to the trigger event, the thermal information including the temperature at a first set of the plurality of junction points of the SoC at the location of the plurality of processing components, and
determine a one of the plurality of processing components with the smallest amount of thermal impact from executing a task over a period of time, the determination based in part on the temperature at the first set of the plurality of junction points.

10. The computer system of claim 9, wherein the task is a new task to be assigned to one of the processing components of the SoC.

11. The computer system of claim 10, further comprising:
a scheduler of the SoC in communication with the NOC bus, the scheduler configured to:
send a signal about the new task to the thermal module, the signal comprising the trigger event, and
assign the new task to the determined one of the plurality of processing components.

12. The computer system of claim 9, wherein:
the plurality of processing components comprises a graphical processing unit (“GPU”) and a central processing unit with at least two cores, all coupled to the NOC bus, and
the SoC further includes a camera and a modem coupled to the NOC bus.

13. The computer system of claim 12, wherein the thermal information about the plurality of processing components comprises:
a present load on the plurality of processing components and a present leakage of the plurality of processing components.

14. The computer system of claim 12, wherein the thermal module is further configured to:
receive thermal information about at least one subsystem of the SoC in response to the trigger event, the thermal information including temperature modeling information about the at least one subsystem and the temperature of the SoC at a second set of the plurality of junction points of the SoC at the location of the at least one subsystem, and
determine a one of the plurality of processing components with the smallest amount of thermal impact from executing a task over a period of time based in part on the temperature at the second set of the plurality of junction points.

15. The computer system of claim 14, further comprising:
a driver of the SoC associated with the at least one subsystem, the driver configured to:
provide the temperature modeling information to the thermal module, the temperature modeling information indicating a present load on the at least one subsystem and a present leakage of the at least one subsystem.

16. The computer system of claim 14, wherein the thermal module is further configured to:
determine a subsystem with the smallest amount of thermal impact from executing the task over the period of time, the determination based in part on the temperature at the first and second set of the plurality of junction points, and
assign the task to the determined subsystem with the smallest amount of thermal impact.

17. A computer system for data path aware thermal management in a portable computing device (“PCD”), the system comprising:
means for receiving a trigger event on a system on a chip (“SoC”);
means for receiving thermal information about a plurality of processing components of the SoC in response to the trigger event, the thermal information including a temperature of the SoC at the locations of the plurality of processing components;
means for predicting a thermal impact from the plurality of processing components executing a task over a period of time;
means for determining a one of the plurality of processing components with the smallest amount of thermal impact from executing the task over the period of time, the determination based in part on the temperature of the SoC at the locations of the plurality of processing components; and
means for assigning the task to the determined one of the plurality of processing components with the smallest amount of thermal impact.

18. The computer system of claim 17, wherein the task is a new task to be assigned to one of the processing components of the SoC.

19. The computer system of claim 18, wherein the means for receiving a trigger event comprises means for receiving a signal from a scheduler of the SoC about the new task to be assigned, and wherein the means for assigning the task to the determined one of the plurality of processing components comprises the scheduler assigning the new task to the determined one of the plurality of processing components.

20. The computer system of claim 17, wherein:
the SoC further comprises a network on chip (“NOC”) bus, the plurality of processing components comprises graphical processing unit (“GPU”) and a central processing unit with at least two cores, all coupled to the NOC bus, and
the SoC further comprises a camera and a modem coupled to the NOC bus.

21. The computer system of claim 20, wherein the thermal information about the plurality of processing components comprises:
a present load on the plurality of processing components and a present leakage of the plurality of processing components.

22. The computer system of claim 17, further comprising:
means for receiving thermal information about at least one subsystem of the SoC in response to the trigger event, the thermal information including temperature modeling information about the at least one subsystem and a second temperature of the SoC at the location of the at least one subsystem, and
wherein the determination of the one of the plurality of processing components with the smallest amount of thermal impact from executing the task over the period of time is further based in part on the second temperature of the SoC at the location of the at least one subsystem.

23. The computer system of claim 22, further comprising:
means for determining a subsystem with the smallest amount of thermal impact from executing the task over the period of time, the determination based in part on the temperature of the SoC at the locations of the plurality of processing components and the second temperature of the SoC at the location of the at least one subsystem; and
means for assigning the task to the determined subsystem with the smallest amount of thermal impact.

24. A computer program product comprising a non-transitory computer usable medium having a computer readable program code embodied therein, said computer readable program code adapted to be executed to implement a method for data path aware thermal management in a portable computing device (“PCD”), the method comprising:
receiving a trigger event at a thermal module of a system on a chip (“SoC”) of the PCD;
receiving at the thermal module thermal information about a plurality of processing components of the SoC in response to the trigger event, the thermal information including a temperature of the SoC at the locations of the plurality of processing components;
predicting a thermal impact from the plurality of processing components executing a task over a period of time;
determining with the thermal module a one of the plurality of processing components with the smallest amount of thermal impact from executing the task over the period of time, the determination based in part on the temperature of the SoC at the locations of the plurality of processing components; and
assigning the task to the determined one of the plurality of processing components with the smallest amount of thermal impact.

25. The computer program product of claim 24, wherein the task is a new task to be assigned to one of the processing components of the SoC.

26. The computer program product of claim 25, wherein receiving a trigger event comprises receiving a signal from a scheduler of the SoC about the new task to be assigned, and wherein assigning the task to the determined one of the plurality of processing components comprises the scheduler assigning the new task to the determined one of the plurality of processing components.

27. The computer program product of claim 24, wherein:
the SoC further comprises a network on chip (“NOC”) bus,
the plurality of processing components comprises a central processing unit with at least two cores, and a graphical processing unit (“GPU”), all coupled to the NOC bus, and the SoC further comprises a camera and a modem coupled to the NOC bus.

28. The computer program product of claim 27, wherein the thermal information about the plurality of processing components comprises:
a present load on the plurality of processing components and a present leakage of the plurality of processing components.

29. The computer program product of claim 24, further comprising:
receiving at the thermal module thermal information about at least one subsystem of the SoC in response to the trigger event, the thermal information including temperature modeling information about the at least one subsystem and a second temperature of the SoC at the location of the at least one subsystem, and
wherein the determination with the thermal module of the one of the plurality of processing components with the smallest amount of thermal impact from executing the task over the period of time is further based in part on the second temperature of the SoC at the location of the at least one subsystem.

30. The computer program product of claim 29, wherein the method further comprises:
determining a subsystem with the smallest amount of thermal impact from executing the task over the period of time, the determination based in part on the temperature of the SoC at the locations of the plurality of processing components and the second temperature of the SoC at the location of the at least one subsystem; and
assigning the task to the determined subsystem with the smallest amount of thermal impact.
